(19) United States
(12) Patent Application Publication
(10) Pub. No.: US 2024/0428251 A1
(43) Pub. Date: Dec. 26, 2024

(54) Cryptocurrency Analysis Process

(71) Applicant: Justin C. Ehrenhofer, Chicago, IL (US)

(72) Inventor: Justin C. Ehrenhofer, Chicago, IL (US)

(21) Appl. No.: 18/337,736

(22) Filed: Jun. 20, 2023

(51) Int. Cl. G06Q 20/40; G06Q 20/06

(52) U.S. Cl. CPC G06Q 20/4016; G06Q 20/065

(57) ABSTRACT

Embodiments included herein are directed towards a method for cryptocurrency record analysis. Embodiments may include storing a plurality of cryptocurrency related digital records at a database and receiving one or more cryptocurrency related digital records for analysis from a user, wherein each record has a corresponding enote. Embodiments may further include analyzing, using a processor, the one or more cryptocurrency related digital records to match the corresponding enote with a transaction from an anonymity pool and generating a report based upon, at least in part, the analyzing.

### BACKGROUND

Cryptocurrencies like Monero, Firo, and others employ advanced cryptographic techniques such as ring signatures or anonymity pool schemes to ensure transaction anonymity. These techniques obfuscate the true sender of a transaction or the creator of a digital record by obfuscating the sender's spent funds amongst funds from other transactions or digital records. Further, these cryptocurrencies may not have public address records, which are relied upon by many other traceability methods. As a result, it becomes challenging to trace the flow of funds or identify the participants in a transaction or digital record.

### SUMMARY

In one or more embodiments of the present disclosure, a computer-implemented method for cryptocurrency record analysis is provided. Embodiments may include storing a plurality of cryptocurrency related digital records at a database and receiving one or more cryptocurrency related digital records for analysis from a user, wherein each record has a corresponding enote. Embodiments may further include analyzing, using a processor, the one or more cryptocurrency related digital records to match the corresponding enote with a transaction from an anonymity pool and generating a report based upon, at least in part, the analyzing.

One or more of the following features may be included. In some embodiments, the plurality of cryptocurrency related digital records may employ ring signatures. The plurality of cryptocurrency related digital records may be stored using a lightning memory-mapped database. The plurality of cryptocurrency related digital records may be stored using a fast key value storage library. The corresponding enotes to be investigated may be known to be related to an illicit actor or other known user. The corresponding enotes to be investigated may be known to be received by a high-risk person. The corresponding enotes to be investigated may be from a transaction returned from a previous analyzing operation. The corresponding enotes to be investigated may be owned by a single entity or a series of related entities. The report may include one or more of a report for investigating criminals as direct recipients of transactions, a report for supporting suspicious activity reports, and a report for determining association of enotes. The plurality of cryptocurrency related digital records may be Monero-based.

In another embodiment of the present disclosure, a system for cryptocurrency record analysis is provided. The system may include a database configured to store a plurality of cryptocurrency related digital records and to receive one or more cryptocurrency related digital records for analysis from a user, wherein each record has a corresponding enote. The system may further include a processor configured to analyze the one or more cryptocurrency related digital records to match the corresponding enote with a transaction from an anonymity pool, the processor further configured to generate a report based upon, at least in part, the analyzing.

One or more of the following features may be included. In some embodiments, the plurality of cryptocurrency related digital records may employ ring signatures. The plurality of cryptocurrency related digital records may be stored using a lightning memory-mapped database. The plurality of cryptocurrency related digital records may be stored using a fast key value storage library. The corresponding output may be known to be related to an illicit actor or other known user. The corresponding output may be known to be received by a high-risk person. The corresponding output may be from a transaction returned from a previous analyzing operation. The corresponding output may be owned by a single entity or a series of related entities. The report may include one or more of a report for investigating criminals as direct recipients of transactions, a report for supporting suspicious activity reports, and a report for determining association of inputs. The plurality of cryptocurrency related digital records may be Monero-based.

Additional features and advantages of embodiments of the present disclosure will be set forth in the description which follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 diagrammatically depicts a cryptocurrency analysis process coupled to a distributed computing network;

FIG. 2 depicts a flowchart showing an example cryptocurrency analysis process consistent with embodiments of the present disclosure;

FIG. 3 depicts a block diagram showing aspects of a cryptocurrency analysis process consistent with embodiments of the present disclosure;

FIG. 4 depicts a block diagram showing aspects of a cryptocurrency analysis process consistent with embodiments of the present disclosure;

FIG. 5 depicts a block diagram showing aspects of a cryptocurrency analysis process consistent with embodiments of the present disclosure; and

FIG. 6 depicts a block diagram showing aspects of a cryptocurrency analysis process consistent with embodiments of the present disclosure.

### DETAILED DESCRIPTION

Embodiments of the present disclosure relate to the field of cryptocurrency analysis, and more particularly, to a system and method for analyzing enotes from various cryptocurrencies that employ ring signatures or other anonymity pool schemes and identifying potential transactions or digital records that have spent one or more user-provided enotes in their anonymity pools. The present disclosure leverages optimized hardware for improved performance and has practical utility for various purposes, including tracking down illicit actors behind ransomware, darknet markets, and other criminal activities.

Reference will now be made in detail to the embodiments of the present disclosure, examples of which are illustrated in the accompanying drawings. The present disclosure may, however, be embodied in many different forms and should not be construed as being limited to the embodiments set forth herein; rather, these embodiments are provided so that this disclosure will be thorough and complete, and will fully convey the concept of the present disclosure to those skilled in the art. Like reference numerals in the drawings denote like elements.

### System Overview

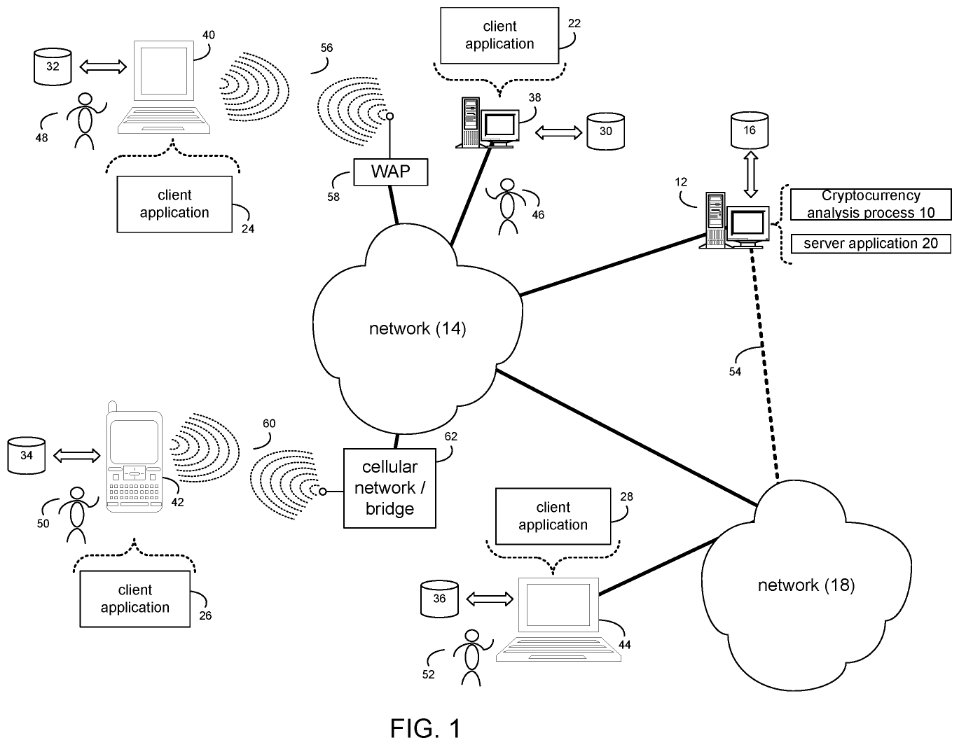

Referring to FIG. 1, there is shown a cryptocurrency analysis process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally and/or alternatively, cryptocurrency analysis process 10 may reside on a client electronic device, such as a personal computer, notebook computer, personal digital assistant, or the like.

The instruction sets and subroutines of cryptocurrency analysis process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, which allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Microsoft Exchange™ Server. Server application 20 may interact with one or more client applications (e.g., client applications 22, 24, 26, 28) in order to execute cryptocurrency analysis process 10. Examples of client applications 22, 24, 26, 28 may include, but are not limited to, design verification tools such as those available from the assignee of the present disclosure. These applications may also be executed by server computer 12. In some embodiments, cryptocurrency analysis process 10 may be a stand-alone application that interfaces with server application 20 or may be applets/applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition/as an alternative to being server-based applications residing on server computer 12, cryptocurrency analysis process 10 may be a client-side application residing on one or more client electronic devices 38, 40, 42, 44 (e.g., stored on storage devices 30, 32, 34, 36, respectively). As such, cryptocurrency analysis process 10 may be a stand-alone application that interface with a client application (e.g., client applications 22, 24, 26, 28), or may be applets/applications that may be executed within a client application. As such, cryptocurrency analysis process 10 may be a client-side process, server-side process, or hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, cryptocurrency analysis process 10 may be a cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™ Redhat Linux™, Apple iOS, ANDROID, or a custom operating system.

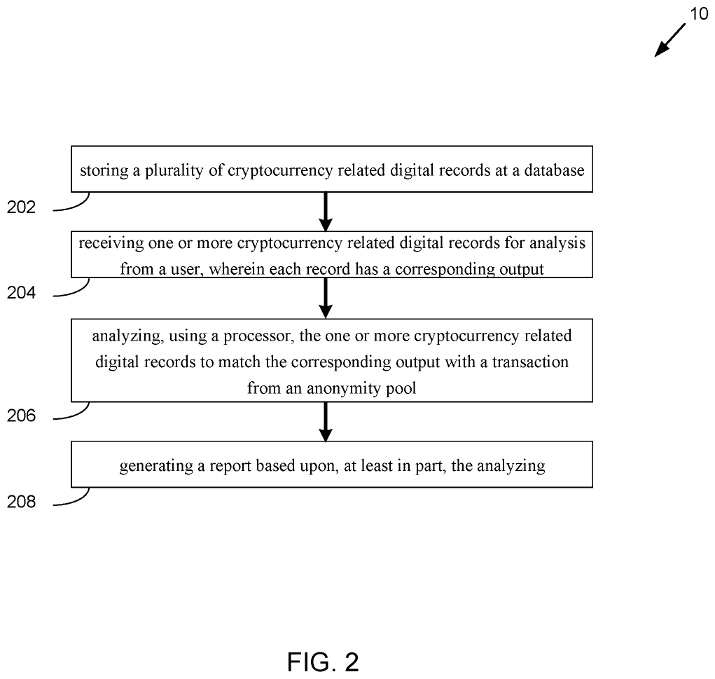

Referring now to FIG. 2, a flowchart showing one or more operations consistent with embodiments of cryptocurrency analysis process 10 is provided. The method may include storing (202) a plurality of cryptocurrency related digital records at a database and receiving (204) one or more cryptocurrency related digital records for analysis from a user, wherein each record has a corresponding enote. Embodiments may further include analyzing (206), using a processor, the one or more cryptocurrency related digital records to match the corresponding enote with a transaction from an anonymity pool and generating (208) a report based upon, at least in part, the analyzing. Numerous additional operations are also within the scope of the present disclosure, which are discussed in further detail hereinbelow.

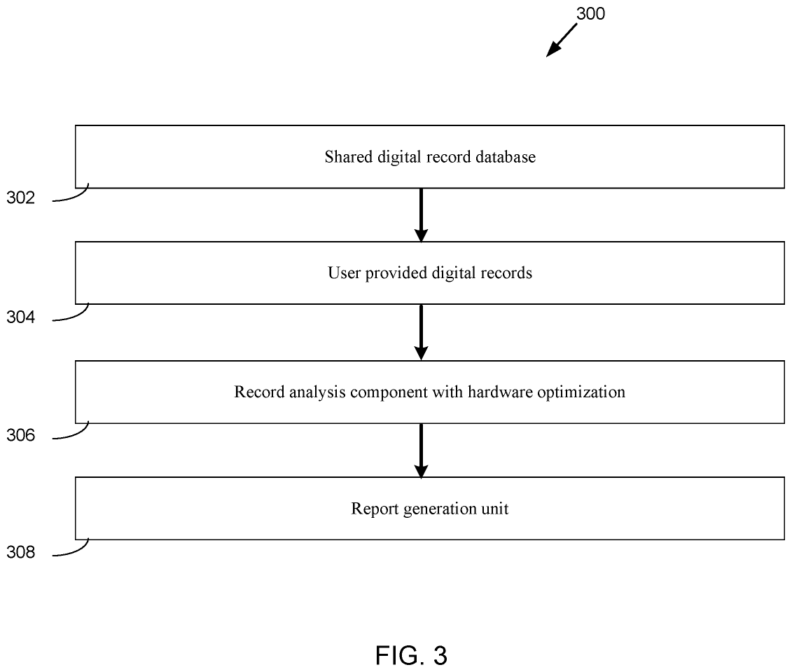

Referring now to FIGS. 3-6, additional diagrams consistent with embodiments of cryptocurrency analysis process 10 are provided. FIG. 3 shows an example diagram 300 showing one example consistent with embodiments of cryptocurrency analysis process 10. This embodiment depicts shared digital record database 302, user provided digital records 304 (e.g., enote A, enote B, transaction ID C, etc.), record analysis component with hardware optimization 306, and report generation unit 308. Each of these aspects are discussed in further detail hereinbelow. The term “enote”, as used herein, may refer to a small message containing an amount of money, an ownership identifier (such as an address) that encapsulates the authority to spend (or approve actions associated with) the enote, and an optional arbitrary memo. “Enote” is often times called an “output”, “transaction output”, or “TXO”.

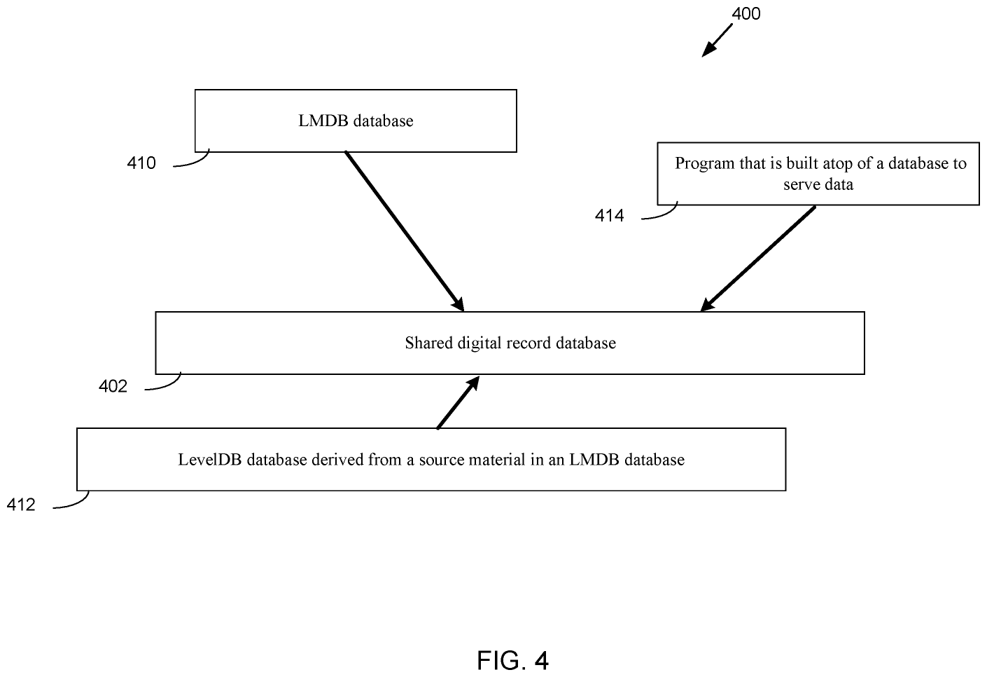

In some embodiments, and referring also to FIG. 4, cryptocurrency analysis process 10 may utilize one or more shared digital records databases (e.g., databases 16, 30, 32, 34, 36, etc.). Some shared digital records databases may include, but are not limited to, lightning memory-mapped databases (LMDB) 410, fast key value storage library (e.g., LevelDB) 412, etc. For example, a LevelDB database may be generated from source material in an LMDB database. Additionally and/or alternatively, a shared digital records database may operate in conjunction with one or more programs 414 that may be built to operate with the database to serve data.

In some embodiments, the digital records database may be used to investigate relationships. Accordingly, embodiments may use the native database for a particular system for which digital records are being investigated, or it may be some derived record. The selected database may serve as the primary source of information for cryptocurrency analysis process 10.

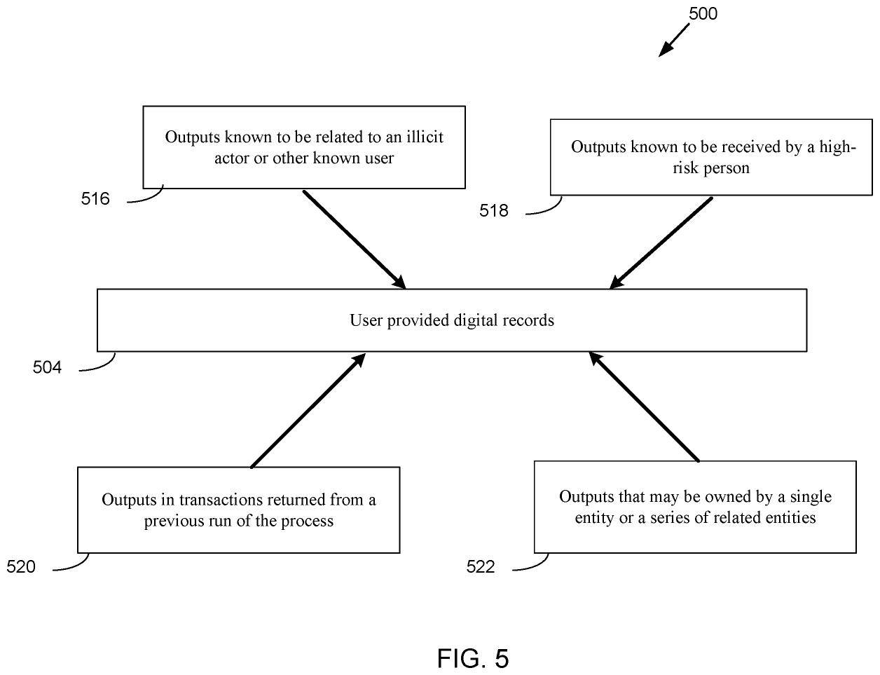

In some embodiments, and referring also to FIG. 5, cryptocurrency analysis process 10 may be configured to receive and/or analyze one or more user-provided digital records. In operation, and as shown in FIG. 5, a user may provide a list of digital records that they wish to be analyzed. These may be records that are known to be related, and/or they may be records that are not known to be related, depending on the particular use of this embodiment.

In some embodiments, the one or more user-provided digital records may be provided using any suitable approach. In some embodiments, a user may run the program locally and provide the records through a command line interface. Additionally and/or alternatively, a user may provide the records through a web interface such as those shown in FIG. 1.

In some embodiments, the one or more user-provided digital records may include one or more enotes 516 known to be received by an illicit actor or other known user. This information may be useful for investigators trying to track down illicit activities, such as money laundering or ransomware attacks, or for users who wish to understand the transaction history of a specific known user. Additionally and/or alternatively, the one or more user-provided digital records may include enotes 518 known to be received by a high-risk person. This may include persons who have been flagged by regulatory authorities, persons with a history of suspicious transactions, or persons who may pose a risk to the financial system. Cryptocurrency analysis process 10 may help analyze the transactions of these high-risk persons and identify potential associations or patterns that warrant further investigation. The one or more user-provided digital records may also include enotes 520 in transactions returned from a previous run or iteration of cryptocurrency analysis process 10. This allows users to refine their analysis and focus on specific enotes or transactions that were previously flagged as potentially related or suspicious, enabling them to better understand the connections between these transactions and users. This also allows for the tracing of records in subsequent transactions. The one or more user-provided digital records may further include a list of enotes 522 that may be owned by a single entity or a series of related entities, but the user may not be sure if they are related. Cryptocurrency analysis process 10 may be configured to analyze these enotes and determine if they are likely to be associated with the same entity or group of related entities. This may be useful for users who want to understand the relationships between different entities in a decentralized network, to identify potential collusion or coordination among users, or to associate different pseudonyms and identities together with a single entity.

It should be noted that these alternative embodiments demonstrate the wide-ranging applicability of the process for analyzing transactions and digital records in a shared database based on various types of user-provided enotes. While these examples are specific, it should be noted that the teachings of the present disclosure is not limited to these use-cases and may be adapted to address various needs across different industries and scenarios.

In some embodiments, cryptocurrency analysis process 10 may be configured to perform analysis of the one or more user-provided digital records using optimized hardware. The record analysis component utilizes specific hardware components. Examples of which may include, but are not limited to, high-performance central processing units (CPU) (e.g., Intel Core i9 or AMD Ryzen 9) and a fast hard drive (e.g., NVMe SSD), to efficiently analyze data from various cryptocurrencies that employ ring signatures or other anonymity pool schemes. Cryptocurrency analysis process 10 may be configured to take advantage of multiple CPU cores and parallel processing capabilities of the chosen CPU, resulting in faster and more efficient analysis.

In operation, record analysis may begin by identifying the oldest enote among the user-provided records and determining its corresponding position (e.g., block height, timestamp, etc.) in the shared database (e.g., blockchain). Cryptocurrency analysis process 10 may then iterate through all transactions or digital records starting from that position and analyze each entry's enotes or participating elements to determine if any of the user-provided enotes were used in the anonymity pools.

In some embodiments, cryptocurrency analysis process 10 may dynamically adjust its workload distribution based on the available hardware resources, ensuring optimal performance. For example, it may use multi-threading techniques to fully utilize the CPU cores, and it may leverage the high-speed data transfer rates of the NVMe SSD to quickly access and process the cryptocurrency data.

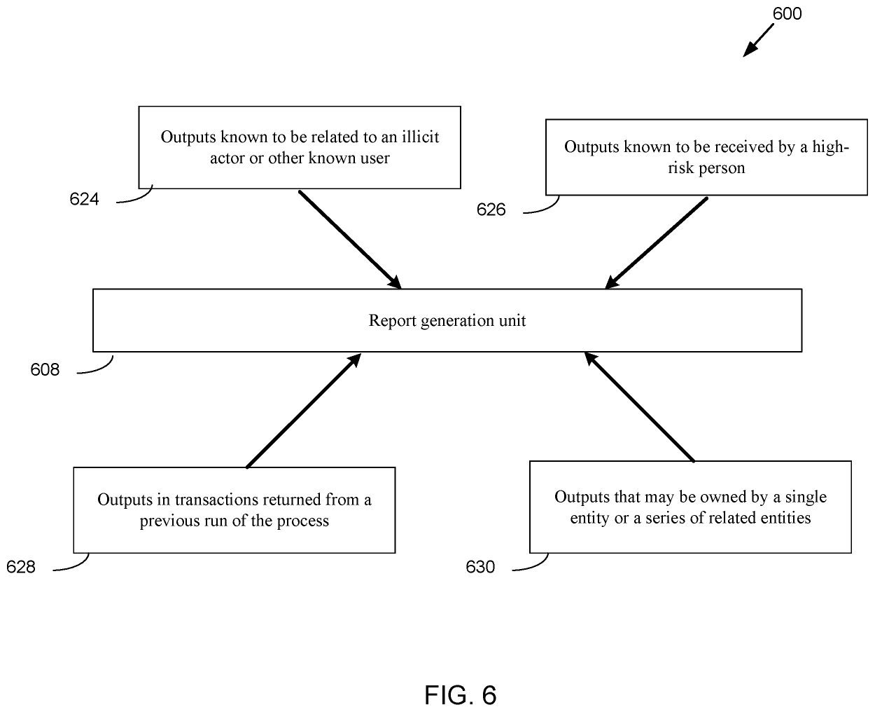

In some embodiments, and referring also to FIG. 6, a report for investigating criminals as direct recipients of transactions may be generated. In this example, the generated report may be aimed at assisting investigators in tracking down criminals who are the direct recipients of transactions, such as those involved in ransomware attacks. Accordingly, the report may provide detailed information about the transactions that involve the user-provided enotes, any associated transactions that could have spent the enotes, and the likelihood that the recipients may be involved in illicit activities. This information can be invaluable for law enforcement agencies and cybersecurity firms working to trace the flow of funds and identify the perpetrators of these crimes.

In some embodiments, the report may be delivered using any suitable approach. For example, a user may receive a printout of the relevant information in a command line interface. Additionally and/or alternatively, a user may be displayed the results on a webpage. In some embodiments, a PDF report may be generated and emailed or otherwise delivered to a user.

In some embodiments, and referring also to FIG. 6, a report for supporting suspicious activity reports (SARs) or for supporting other compliance purposes may be generated. In some cases, the report may be designed to provide additional information for cryptocurrency exchanges that need to file a Suspicious Activity Report (SAR) for a particular user. Accordingly, the report may analyze the user's transactions, identifying any patterns or associations that may indicate suspicious behavior. By providing a comprehensive view of the user's transaction history, the report may help the exchange make a more informed decision about whether to file an SAR and assist regulatory authorities in their investigations.

In some embodiments, a report for investigating the possible relationship between entities may be generated. In this example, the report may be configured to determine if a list of enotes provided by a user are not known to be associated, but the report may indicate if the enotes are likely to be part of an associated single entity or group of similar/related entities. This information may be useful for various purposes, such as analyzing the behavior of a group of users in a decentralized network, identifying potential collusion or coordination among users, or even assessing the risk associated with a particular set of enotes. By providing insights into the associations between enotes, the report may help users make more informed decisions and better understand the dynamics of the network.

In some embodiments, and referring also to FIG. 6, a report for a tailored incident response situation, such as response to an incident such as ransomware or stolen cryptocurrency funds, may be generated. Reports of the findings can be tailor-made to wide-ranging circumstances. These incident response reports are especially critical at providing comprehensive, accurate information to victims and other individuals to provide actionable next steps. The embodiments included herein demonstrate the wide-ranging applicability of cryptocurrency analysis process 10 for generating reports based on the analysis of transactions and digital records in a shared database. While these examples are specific, the teachings of the present disclosure are not limited to these examples and may be adapted to address various needs across different industries and scenarios.

As discussed herein, cryptocurrency analysis process 10 may be applicable to various cryptocurrencies and digital records that employ ring signatures or other anonymity pool schemes. In operation, cryptocurrency analysis process 10 begin as user inputs may be received for a list of digital records to investigate and other configuration parameters, such as the target cryptocurrency or digital record system, hardware settings, and optimization parameters. Cryptocurrency analysis process 10 may then initialize optimized hardware components, such as a high-performance CPU and a fast hard drive and configure the program for multi-threading or parallel processing as needed. Cryptocurrency analysis process 10 may then identify the oldest enote among the user-provided enotes and determine its corresponding position (e.g., block height, timestamp, etc.) in the shared database (e.g., blockchain, distributed ledger, etc.). Cryptocurrency analysis process 10 may then iterate through all transactions or digital records starting from the identified position or iterate through the entire shared database if desired. For each transaction or digital record, the process may analyze its enotes or participating elements and check if any of the user-provided enotes were used in the anonymity pools. If a match is found, the process may store the transaction or digital record details. Cryptocurrency analysis process 10 may sort the stored transaction or digital record details based on the number of initially provided enotes that appeared in their anonymity pools and then generate a report summarizing the results and present it to the user.

In some embodiments, cryptocurrency analysis process 10 may use a database application programming interface (API) available with the Monero-onion-explorer software for use with the Monero network, though other embodiments may use additional and/or alternative databases and may work on other networks as described earlier. For example, some embodiments may utilize the Python 3 programming language, though other embodiments can use another programming languages.

Cryptocurrency analysis process 10 may be used to handle a wide variety of situations and find use to address numerous issues in the marketplace. One particular example non-limiting is provided below. There is a victim of ransomware, who wishes to pay the ransom in Monero. The victim (or their consultants) makes a test payment and wait for a confirmation from the ransomware actor. After confirmation, the victim pays the remainder of the ransom. The victim collects details of the payments to the illicit actor. The victim optionally has these details prepared in a report. The report contains, but is not limited to, the transaction ID and the specific enotes that are given to the illicit actor. This payment report is often given as a part of a police report or other similar report. The victim, law enforcement, or another person decide that they wish to investigate this transaction using cryptocurrency analysis process 10. They provide the tool with the most specific information that they have: the specific enotes given to the illicit actor, or the transaction IDs sent to the threat actor. To get the most accurate results, they should have the specific enotes. They provide this information in the software. This can be a cloud-based program, where a user logs in and provides these details through a web portal, and/or a desktop program. In some embodiments, the program may identify which of the provided enotes or transactions is the oldest and sets the block in which this occurred as the initial starting scan point. The tool scans all transaction records in the blockchain (or those from the date marked earlier) to see if any of the records appear to spend the funds. In Monero's case, the tool may specifically search for the user-provided enotes or enotes involved in the user-provided transactions to occur in ring signatures. These are possible spends. The process may search for cases where two or more of these enotes are spent in the same transaction. The program enotes results: the transaction IDs of all transactions that could have spent one or more of the enotes, sorted by the number of enotes that were spent in the transaction, descending. This report may be more detailed, such as showing timestamps, suspected IP addresses (if available), information on the (if known) nature of Monero transactions details (e.g., if it is likely to be a mining-related enote or not using heuristics, or classification by another heuristic), recommended future runs of the tool based on what it learned, etc. The report may include this list of transactions described above. This report may be provided to and used by law enforcement. Law enforcement, through cryptocurrency analysis process 10 may ask centralized, regulated exchanges if they have received the suspected transactions. If they have, then they should prepare evidence and ask the exchange for information that they have on the relevant transaction and on the user involved with the relevant transaction. Law enforcement should ask any other relevant parties about the transaction. Third-parties may communicate with cryptocurrency analysis process 10 to share which Monero transactions and enotes they are associated with, and law enforcement may query the database to learn the relevant party involved with the transaction and their contact details.

Embodiments of cryptocurrency analysis process 10 may be used to assist law enforcement agencies in tracing and identifying illicit actors behind ransomware attacks, darknet markets, and other criminal activities that use cryptocurrencies with anonymity features for anonymous transactions or digital records. The process may also provide compliance tools for cryptocurrency exchanges and financial institutions to monitor and analyze transactions or digital records for regulatory purposes. The process may further enable researchers to study transaction patterns and develop new techniques for improving privacy and security in cryptocurrency networks. By integrating optimized hardware utilization and focusing on user-provided enotes, embodiments of the present disclosure offer a more efficient and targeted approach to enote analysis for multiple cryptocurrencies, enabling its use for various investigative and research purposes.

Embodiments of cryptocurrency analysis process 10 may provide numerous advantages over existing approaches. The system is versatile in that it is designed to work with multiple cryptocurrencies and digital record systems that employ ring signatures or other anonymity pool schemes, making it adaptable for various use cases and applications. By utilizing optimized hardware components such as high-performance CPUs and fast hard drives, the system is capable of processing large amounts of data quickly and efficiently. The program is scalable as it is designed for parallel processing and multi-threading, allowing it to take advantage of multiple CPU cores and further increase its processing speed and performance. The system analyzes all transactions or digital records from the earliest relevant point in the shared database, ensuring that no potentially relevant information is overlooked. The process provides for a clear record recording process, reducing uncertainty and false positives in the tracing process. The system is particularly useful for frequent, high-stakes use-cases, including but not limited to investigating illicit actors who release ransomware malware and actors who operate darknet marketplaces of illegal goods and services. The system is modular, allowing for further uses of the process when new information is learned as a result of the process or as a result of new information obtained through other means. The system allows for straightforward testing of arbitrary digital records to see if they have statistically likely associations with each other. Users can provide a list of enotes or elements they wish to investigate, giving them control over the scope and focus of their analysis. The system generates a comprehensive report summarizing the results of the analysis, including transactions or digital records that used the provided enotes in their anonymity pools and the number of initially provided enotes that appeared in each.

Several prior art references attempt to analyze cryptocurrency transactions and improve traceability. However, these methods often do not specifically target user-provided records or leverage optimized hardware utilization for improved performance. In contrast, embodiments of the present disclosure address these limitations by providing a more efficient and targeted record analysis system that can be employed for various investigative purposes and applied to multiple cryptocurrencies. Unlike other methods, the present disclosure is designed for tracing through these more opaque systems.

It will be apparent to those skilled in the art that various modifications and variations can be made to cryptocurrency analysis process 10 and/or embodiments of the present disclosure without departing from the spirit or scope of the invention. Thus, it is intended that embodiments of the present disclosure cover the modifications and variations of this invention provided they come within the scope of the appended claims and their equivalents.

What is claimed is:

1. A computer-implemented method for cryptocurrency record analysis comprising:
storing a plurality of cryptocurrency related digital records at a database;
receiving one or more cryptocurrency related digital records for analysis from a user, wherein each record has a corresponding enote;
analyzing, using a processor, the one or more cryptocurrency related digital records to match the corresponding enote with a transaction from an anonymity pool; and
generating a report based upon, at least in part, the analyzing.

2. The computer-implemented method of claim 1, wherein the plurality of cryptocurrency related digital records employ ring signatures.

3. The computer-implemented method of claim 1, wherein the plurality of cryptocurrency related digital records are stored using a lightning memory-mapped database.

4. The computer-implemented method of claim 1, wherein the plurality of cryptocurrency related digital records are stored using a fast key value storage library.

5. The computer-implemented method of claim 1, wherein the corresponding enote is known to be related to an illicit actor or other known user.

6. The computer-implemented method of claim 1, wherein the corresponding enote is known to be received by a high-risk person.

7. The computer-implemented method of claim 1, wherein the corresponding enote is from a transaction returned from a previous analyzing operation.

8. The computer-implemented method of claim 1, wherein the corresponding enote is owned by a single entity or a series of related entities.

9. The computer-implemented method of claim 1, wherein the report includes one or more of a report for investigating criminals as direct recipients of transactions, a report for supporting suspicious activity reports, and a report for determining association of enotes.

10. The computer-implemented method of claim 1, wherein the plurality of cryptocurrency related digital records are Monero-based.

11. A system for cryptocurrency record analysis comprising:
a database configured to store a plurality of cryptocurrency related digital records and to receive one or more cryptocurrency related digital records for analysis from a user, wherein each record has a corresponding enote; and
a processor configured to analyze the one or more cryptocurrency related digital records to match the corresponding enote with a transaction from an anonymity pool, the processor further configured to generate a report based upon, at least in part, the analyzing.

12. The system for cryptocurrency record analysis of claim 11, wherein the plurality of cryptocurrency related digital records employ ring signatures.

13. The system for cryptocurrency record analysis of claim 11, wherein the plurality of cryptocurrency related digital records are stored using a lightning memory-mapped database.

14. The system for cryptocurrency record analysis of claim 11, wherein the plurality of cryptocurrency related digital records are stored using a fast key value storage library.

15. The system for cryptocurrency record analysis of claim 11, wherein the corresponding enote is known to be related to an illicit actor or other known user.

16. The system for cryptocurrency record analysis of claim 11, wherein the corresponding enote is known to be received by a high-risk person.

17. The system for cryptocurrency record analysis of claim 11, wherein the corresponding enote is from a transaction returned from a previous analyzing operation.

18. The system for cryptocurrency record analysis of claim 11, wherein the corresponding enote is owned by a single entity or a series of related entities.

19. The system for cryptocurrency record analysis of claim 11, wherein the report includes one or more of a report for investigating criminals as direct recipients of transactions, a report for supporting suspicious activity reports, a report for determining association of enotes, and a report for an incident response situation.

20. The system for cryptocurrency record analysis of claim 11, wherein the plurality of cryptocurrency related digital records are Monero-based.
